(19) United States
(12) Patent Application Publication
(10) Pub. No.: US 2010/0256280 A1
(43) Pub. Date: Oct. 7, 2010

(54) METHODS OF FORMING RESIN AND FILLER COMPOSITE SYSTEMS

(75) Inventor: Karen J. Bruzda, Cleveland, OH (US)

Correspondence Address: HARNESS, DICKEY, & PIERCE, P.L.C, 7700 Bonhomme, Suite 400, ST. LOUIS, MO, 63105, US

(73) Assignee: Laird Technologies, Inc., Chesterfield, MO (US)

(21) Appl. No.: 12/419,965

(22) Filed: Apr. 7, 2009

(51) Int. Cl. C08K 3/38; C08L 75/04

(52) U.S. Cl. 524/404; 524/589

(57) ABSTRACT

A method of forming a resin and filler composite system generally includes softening a polymer formed by a moisture sensitive chemical reaction of one or more monomers, and adding at least one or more fillers to the softened polymer to form a resin and filler composite system. Formation of foam is substantially inhibited when adding at least one or more fillers to the softened polymer.

### FIELD

The present disclosure relates generally to methods of forming resin and filler composite systems, and more particularly to methods of forming resin and filler composite systems having, for example, enhanced thermal conductivities, etc.

### BACKGROUND

This section provides background information related to the present disclosure which is not necessarily prior art.

Resin and filler composite systems, such as those including thermoplastic resins with fillers (e.g., thermally conductive fillers, etc.) incorporated therein, can be used in numerous applications. For example, the composite systems may be used in connection with thermally conductive applications. As an example, the composite systems may be used to form contact pads (e.g., thermal pads, gap pads, gap fillers, etc.) for use in dissipating heat from electrical components and passing the heat to cooling elements (e.g., heat sinks, cooling fans, etc.). Resin and filler composite systems may also be used in connection with electrical shielding applications. For example, the composite systems may be used to form gaskets for sealing joints, gaps, etc. in electromagnetically shielded housings for use in inhibiting ingress and/or egress of electromagnetic interference (EMI) and/or radio frequency interference (RFI) to and/or from electronic devices within the housings.

Typically, resin and filler composite systems are formed by adding fillers to monomers, the precursors of the thermoplastic resins, before the monomers are polymerized (e.g., reacted, cross-linked, etc.) to form the thermoplastic resins. Following the reaction process, the thermoplastic resins will thus have the fillers incorporated therein (forming the resin and filler composite systems). However, the monomers (prior to being polymerized) and/or the polymerization reaction are often moisture sensitive. Any moisture present on surfaces of the fillers added to the monomers (prior to the monomers being polymerized) can result in formation of foam when the monomers are polymerized (e.g., the moisture can cause additional, undesirable chemical reactions to occur during the polymerization process, which in turn produce the foam, etc.). This foam can create air pockets (and/or voids) within the thermoplastic resins (and thus within the formed resin and filler composite systems) that can adversely affect strength, thermally conductive properties, electrically conductive properties, etc. of the formed resin and filler composite system.

To help control the moisture and/or foaming concerns, fillers are often added to the monomers under controlled environments before the monomers are polymerized. For example, the fillers may be added to the monomers under altered pressures (e.g., vacuums, etc.), under altered atmospheres (e.g., low humidity, nitrogen blanketed, etc.), after complex filler preparation (e.g., drying the fillers, cooling the filler/monomer mixture under dry conditions, etc.) etc. such that when the monomers are synthesized, the formation of foam may be limited. However, providing such complex filler preparation and/or controlled environments can be costly, time consuming, and/or unproductive. Accordingly, methods of forming resin and filler composite systems without requiring such controlled environments would be desirable.

### SUMMARY

This section provides a general summary of the disclosure, and is not a comprehensive disclosure of its full scope or all of its features.

Example embodiments of the present disclosure are generally directed toward methods of forming resin and filler composite systems. In one example embodiment, a method of forming a resin and filler composite system generally includes softening a polymer formed by a moisture sensitive chemical reaction of one or more monomers, and adding at least one or more fillers to the softened polymer to form a resin and filler composite system. Formation of foam is substantially inhibited when adding at least one or more fillers to the softened polymer.

In another example embodiment, a method of forming a resin and filler composite system generally includes softening a thermoplastic and adding at least one or more fillers to the softened thermoplastic to achieve a thermal conductivity of at least about 0.5 Watts per meter-Kelvin.

In another example embodiment, a method of forming a thermoplastic and boron nitride composite system that is substantially free of silicone generally includes heating a thermoplastic to at least about 95 degrees Celsius to generally liquefy the thermoplastic, and adding boron nitride to the liquefied thermoplastic to achieve a thermal conductivity of at least about 3.5 Watts per meter-Kelvin.

Further areas of applicability will become apparent from the description provided herein. The description and specific examples in this summary are intended for purposes of illustration only and are not intended to limit the scope of the present disclosure.

### DRAWING

The drawing described herein is for illustrative purposes only of a select embodiment and not all possible implementations, and is not intended to limit the scope of the present disclosure.

FIG. 1 is a flow diagram illustrating an example method of forming a resin and filler composite system including one or more aspects of the present disclosure.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the term “and/or” includes any and all combinations of one or more of the associated listed items. Terms such as “first,” “second,” other numerical terms, “next,” etc., when used herein, do not imply a sequence or order unless clearly indicated by the context.

As previously stated, resin and filler composite systems are typically formed by adding fillers to monomers before the monomers are reacted to form polymers, and then polymerizing the monomers (with the fillers added thereto) to form the resin and filler composite systems. As used herein, polymers are the reaction products of at least one or more chemical reactions of the monomers. The monomers and/or the reaction process of them (prior to being polymerized), however, are often moisture sensitive. Any moisture present on surfaces of the fillers added to the monomers (prior to the monomers being polymerized) can result in formation of foam when the monomers are reacted. This foam can create air pockets (and/or voids) within the polymers (and thus within the formed resin and filler composite systems) that can adversely affect strength, thermally conductive properties, electrically conductive properties, etc. of the formed resin and filler composite system.

Example embodiments of the present disclosure generally relate to novel, improved methods of forming resin and filler composite systems. Example methods generally include adding at least one or more fillers to polymers, after the polymers are synthesized from monomers, to thereby form resin and filler composite systems that have, for example, enhanced thermal conductivities, etc. Any moisture present on surfaces of the fillers added to the polymers (after synthesis of the monomers) will have little or no detrimental effect on the formed resin and filler composite systems because there is substantially no unreacted moisture-sensitive material left in the polymers with which the moisture can react.

Chemical reactions by which the monomers may be reacted to form the polymers are generally known and may include any suitable chemical reaction process that polymerizes the monomers. This reaction reduces (if not eliminates) the sensitivity of the monomers to moisture since the polymer produced is no longer moisture sensitive. Other example processes useful for eliminating the sensitivity of the monomers to moisture include, for example, moisture-sensitive chemical reaction processes, monomer-involved polymerization processes, curing processes, etc. may be used.

In addition, the fillers can be added to the polymers by acceptable operations. For example, the polymers can be generally softened by suitable means, and the fillers then added to the softened polymers. Softening the polymers may include, for example, heating the polymers to temperatures generally at or above their softening temperatures to reduce their viscosity within the scope of the present disclosure. The fillers can be added (e.g., mixed, blended, roll milled, etc.) to the softened polymers as desired.

In example methods of the present disclosure where softening the polymers (in preparation for adding fillers) includes heating the polymers, the polymers can be heated to temperatures generally at or above their softening temperatures by suitable passive heating operations or active heating operations, including, for example actively heating the polymers in an industrial oven, etc. within the scope of the present disclosure. The softening temperatures of the polymers may be any temperature suitable for softening the polymers such that fillers can be added (e.g., a temperature of 1 degree Celsius above room temperature, a temperature of 100 degrees Celsius, a temperature of 150 degrees Celsius, a temperature above, below, or at room temperature, etc.). In one example method, softening a polymer includes heating the polymer generally to its melting temperature such that the polymer liquefies. It should be appreciated, however, that polymers need not be completely liquefied in order to add fillers. For example, some embodiments may include adding fillers to a polymer (e.g., that has not been liquefied, etc.) where the polymer is sufficiently soft and/or has a viscosity sufficient to allow the addition of and receipt of fillers. By way of further example, the viscosity of the polymer may be reduced, for example, through active heating (e.g., actively applying heat by heating the polymer in an industrial oven, etc.) and/or through passive heating (e.g., exposing the polymer to the ambient environment and allowing the polymer to passively heat up to ambient or room air temperature, etc.). Further, it should be appreciated that the polymers can be actively or passively heated and cooled (e.g., solidified, etc.) as desired (and repeatedly, if necessary) for adding the fillers. The polymers may include, for example, thermoplastic characteristics which allow for the repeated heating and cooling of the polymers without adversely affecting their chemical, physical, etc. characteristics, properties, etc.

Example polymers suitable for use in forming resin and filler composite systems in accordance with the methods of the present disclosure may include (but are not limited to) polyurethanes, thermoplastics (e.g., thermoplastic polyurethanes, thermoplastic resins, etc.), polystyrenes, polyethylenes, polyacrylates, polybutadienes, polybutylene terephthalates, etc. within the scope of the present disclosure. In some example embodiments, example polymers may be synthesized via a moisture sensitive reaction, from moisture sensitive monomers, etc. The selected example polymers should be generally soft at room temperature to promote addition of fillers thereto, but relatively temperature stable such that they exhibit minimal or at least reduced/insignificant degradation and/or volatility at elevated operational temperatures (e.g., at temperatures which the resin and filler composite systems will be used in thermal operations, electrical operations, etc., such as, for example, as thermal gap pads at operating temperatures around about 120 degrees Celsius, etc.).

In some example embodiments, example polymers suitable for use in forming resin and filler composite systems in accordance with the methods of the present disclosure may be substantially free of silicone (e.g., silicon free, etc.). For example, in such example embodiments the polymers may include a de minimis or trivial amount of silicone, where that amount is low enough so as to not adversely affect end use applications of the polymers, which typically would be adversely affected by the presence of silicone. In other example embodiments, example polymers may be entirely free of silicone.

Fillers used in connection with forming the example resin and filler composite systems may include, for example, thermally conductive filler materials, electrically conductive filler materials, etc. such that the resultant example resin and filler composite systems thus include, for example, greater thermal conductivities, greater electrical conductivities, etc. than the polymers alone (e.g., without fillers, etc.) to which the fillers are added. Further, at least one or more of the added fillers may include thermally conductive materials and electrically conductive materials such that the resultant resin and filler composite systems include, for example, greater thermal conductivities and greater electrical conductivities than the polymers alone.

Example fillers suitable for addition to polymers for use in forming resin and filler composite systems in accordance with the methods of the present disclosure may include (but are not limited to) carbon fillers (e.g., carbon fibers, carbon powder, carbon black, etc.), metallic fillers (e.g., copper powder, steel, aluminum powder, aluminum flake, etc.), ceramic fillers (e.g., boron nitride, aluminum nitride, aluminum oxide, zinc oxide, etc.), quartz, etc. within the scope of the present disclosure.

The example methods of the present disclosure can generally provide resin and filler composite systems having, for example, improved thermally conductive properties (e.g., improved thermal conductivity, etc.), improved electrically conductive properties, etc. The resin and filler composite systems formed by the example methods of the present disclosure may be used, for example, in electronic applications for help dissipating heat from electronic components and passing the heat to cooling elements (e.g., heat sinks, cooling fans, etc.), for help sealing gaps, corners, edges, etc. in electromagnetically shielded housings (e.g., for electrical components, etc.) against ingress and/or egress of electromagnetic interference (EMI) and/or radio frequency interference (RFI), etc. And, the example resin and filler composite systems may be formed into desired shapes (e.g., foam-free shapes, etc.) for use as, for example, thermal pads, gap pads, gaskets, EMI pads, etc. within the scope of the present disclosure.

Resin and filler composite systems formed according to example methods of the present disclosure may have thermal conductivities ranging from about 0.5 Watts per meter-Kelvin (W/mK) to about 20 W/mK, and preferably from about 1 W/mK to at least about 4.0 W/mK. For example, resin and filler composite systems formed according to example methods of the present disclosure may have thermal conductivities of at least about 3 W/mK, and preferably at least about 3.5 W/mK, etc. Alternatively, resin and filler composite systems formed according example methods of the present disclosure may have thermal conductivities less than about 0.5 W/mK or greater than about 20 W/mK within the scope of the present disclosure.

Further, resin and filler composite systems formed according to example methods of the present disclosure may have densities of at least about 1 gram per cubic centimeter (g/cm³). In one example embodiment, a resin and filler composite system includes a density of about 1.35 g/cm³. Resin and filler composite systems may have densities of less than or greater than about 1 g/cm³ within the scope of the present disclosure.

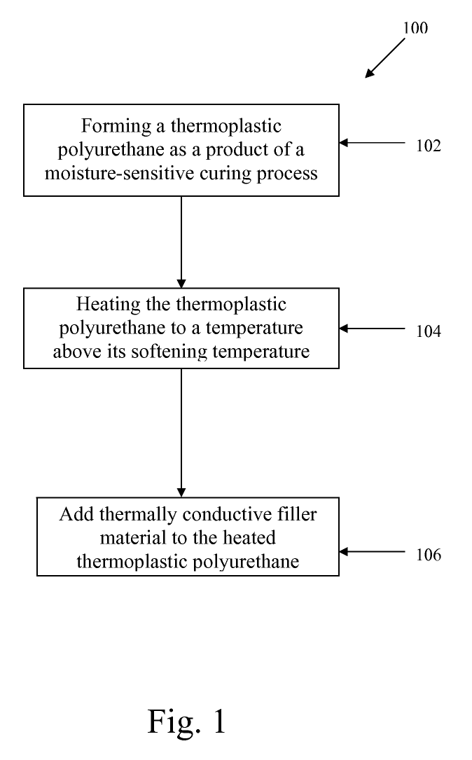

Referring now to the flow diagram of FIG. 1, an example method including one or more aspects of the present disclosure for forming a resin and filler composite system is indicated generally at reference number 100. In this example method 100, the resin and filler composite system is formed from a thermoplastic polyurethane to which a thermally conductive filler material is added. The thermoplastic polyurethane and the thermally conductive filler material used in this example method 100 may be selected, for example, based on desired characteristics (e.g., silicone content, initial hardness, viscosity properties, etc.) and/or final intended use (e.g., use as a gap filler, gap pad, etc.).

As generally indicated at reference number 102, the selected thermoplastic polyurethane is formed as a product of a moisture-sensitive chemical reaction curing process involving monomers. This occurs prior to adding the thermally conductive filler material to the thermoplastic polyurethane to reduce (if not eliminate) any detrimental effects moisture located on surfaces of the thermally conductive filler material may have on the moisture-sensitive chemical reaction curing process (e.g., to help inhibit formation of foam during the moisture-sensitive chemical reaction curing process, etc.).

In the example flow diagram, the selected thermoplastic polyurethane is heated to or above its softening temperature (e.g., melting temperature, etc.). This heating operation is generally indicated at reference number 104, and includes substantially reducing the viscosity of the thermoplastic polyurethane (e.g., liquefying the thermoplastic polyurethane, etc.). As indicated at reference number 106, while the thermoplastic polyurethane is heated to the temperature at or above its softening temperature, at least one or more thermally conductive filler materials are added thereto to produce the resin and filler composite system. The resin and filler composite system has, for example, at least one or more of improved thermally conductive properties (e.g., improved thermal conductivity, etc.), improved electrically conductive properties, etc.

The following example is merely illustrative, and does not limit this disclosure in any way.

### EXAMPLE

### Example 1

In one example, a resin and filler composite system including one or more aspects of the present disclosure was generally formed using thermoplastic polyurethane and boron nitride fillers. The particular thermoplastic polyurethane and boron nitride fillers were selected based generally on desired softening properties and desired operational properties, for example, use as a silicone-free gap filler (or gap pad) in silicone sensitive applications such as fiber optic applications, automotive modules, disk drives, plasma display panels, liquid crystal display panels, etc. In this example, the selected thermoplastic polyurethane is formed as a product of moisture-sensitive chemical reaction curing processes involving select monomers.

The selected thermoplastic polyurethane exhibits, for example, an instantaneous hardness (on the Shore durometer ◯◯◯ scale) of about 75 at room temperature (as measured according to American Society for Testing and Materials (ASTM) standard D2240-00). And, the thermoplastic polyurethane reached a Shore ◯◯◯ hardness of about 0 in about 28 seconds upon sitting at room temperature with the hardness probe continually measuring hardness. In addition, the thermoplastic polyurethane exhibits a viscosity of about 160,000 centipose (cps) at a temperature of about 90 degrees Celsius (as measured using an RV7 Brookfield spindle operated at about two rotations per minute, and according to ASTM standard D6267-08), and exhibits weight loss of less than about 0.5 percent when maintained at a temperature of about 120 degrees Celsius for about 20 hours (as measured by Thermogravimetric Analysis (TGA) in an oxygenated atmosphere).

To form the resin and filler composite system of this example, the thermoplastic polyurethane was initially heated to a temperature of about 95 degrees Celsius to substantially reduce its viscosity. This formed a generally liquefied substance to which the boron nitride fillers were added (e.g., mixed, etc.) to produce the resin and filler composite system.

While still warm, the resin and filler composite system was then processed for use as gap fillers. For example, the warm resin and filler composite system was formed, etc. into sheets of material with release liners (e.g., for protection of the formed gap fillers during cutting, shipping, etc.) added to both sides of the sheets for final distribution, etc. as gap fillers. Alternatively, it should be appreciated that the warm resin and filler composite system could be allowed to cool (by suitable cooling operations) after the fillers are added, and then subsequently re-warmed to be processed into gap fillers. The resin and filler composite system (and release liners) where then processed into desired sizes, shapes, etc. for gap fillers.

A polyurethane gap filler formed according to this example may include a non-silicone film having a generally dark pink color. The gap filler may also generally include a density of about 1.4 grams per cubic centimeter and can be processed into thicknesses ranging from about 0.5 millimeters to about 5.0 millimeters. The polyurethane gap filler may have colors other than dark pink (e.g., white, etc.) within the scope of the present disclosure.

The example gap filler can generally be used in operation over temperatures ranging from about −20 degrees Celsius to about 120 degrees Celsius, and may exhibit a thermal conductivity of at least about 3.5 Watts per meter-Kelvin. In addition, the gap filler (at an initial thickness of about 1.0 millimeters (about 0.04 inches)) may exhibit a thermal resistance of about 0.177 degrees Celsius-square inch per Watt at a pressure of about 10 pounds per square inch, and at an average temperature of about 50 degrees Celsius (wherein after testing, a thickness of the gap filler was about 13 mils (about 0.33 millimeters, or about 0.013 inches) due to the heat and/or pressure of testing). Moreover, the example gap filler may exhibit a volume resistivity of about 6×10¹² ohm-centimeters at a temperature of about 25 degrees Celsius, a dielectric constant of about 4.6 at a frequency of about 1 kilohertz, and a voltage breakdown of about 10,000 volts AC at a thickness of about 1 millimeter.

The example gap filler further may exhibit the following deflection percentages. At a thickness of about 1 millimeter and a temperature of about 25 degrees Celsius, the gap filler may exhibit a deflection of about 5 percent under a pressure of about 20 pounds per square inch, a deflection of about 8 percent under a pressure of about 50 pounds per square inch, and a deflection of about 12 percent under a pressure of about 100 pounds per square inch. At a thickness of about 1 millimeter and a temperature of about 50 degrees Celsius, the gap filler may exhibit a deflection of about 10 percent under a pressure of about 20 pounds per square inch, a deflection of about 30 percent under a pressure of about 50 pounds per square inch, and a deflection of about 55 percent under a pressure of about 100 pounds per square inch. And at a thickness of about 1 millimeter and a temperature of about 70 degrees Celsius, the gap filler may exhibit a deflection of about 12 percent under a pressure of about 20 pounds per square inch, a deflection of about 43 percent under a pressure of about 50 pounds per square inch, and a deflection of about 62 percent under a pressure of about 100 pounds per square inch.

Still further, the example gap filler may exhibit hardness values (on the Shore durometer ◯◯ scale with about a three second test time) of about 85 at a temperature of about 25 degrees Celsius, of about 75 at a temperature of about 40 degrees Celsius, of about 60 at a temperature of about 70 degrees Celsius, of about 40 at a temperature of about 90 degrees Celsius, and of about 30 at a temperature of about 110 degrees Celsius.

In the above example, thermal conductivity and thermal resistance were evaluated based on ASTM D5470: “Standard Test Method for Thermal Transmission Properties of Thermally Conductive Electrical Insulation Materials,” using a platen having a diameter of about 28.65 millimeters. The method was modified, however, to use 10 pounds per square inch of pressure. Deflection percentages relative to pressures where evaluated based on ASTM D575: “Standard Test Method for Rubber Properties in Compression.” Hardness was evaluated based on ASTM D2240: “Standard Test Method for Rubber Property-Durometer Hardness.” Volume resistivity was evaluated based on ASTM D257: “Standard Test Methods for DC Resistance or Conductance of Insulating Materials.” And the dielectric constant was evaluated based on ASTM D150: “Standard Test Methods for AC Loss Characteristics and Permittivity (Dielectric Constant) of Solid Electrical Insulation.”

It should be appreciated that numerical values are provided in this example, and in this disclosure, for illustrative purposes only. The particular values provided are not intended to limit the scope of the present disclosure.

The example methods of the present disclosure may allow for adding fillers to polymers in generally standard environments, for example, without the use of altered compositions, altered pressures (e.g., vacuums, etc.), altered atmospheres (e.g., low humidity, nitrogen blanketed, etc.), etc. typically required for controlling moisture and/or foaming concerns associated with traditional methods of forming resin and filler composite systems. Moreover, the formed resin and filler composite systems are substantially water insensitive, and therefore don't require complex filler preparation when being formed, etc.

It should be appreciated that in example embodiments of the present disclosure, the thermoplastic nature of the resin and filler composite systems (e.g., of the polymers thereof, etc.) is used to advantage. Fillers are not incorporated until after monomers are reacted to form polymers having thermoplastic characteristics. The thermoplastic polymers are capable of being heated to or above their softening temperatures, reducing their viscosity significantly, so that the fillers can be easily introduced and blended into the polymers by usual methods.

Some example polymers, as described herein, may include at least one or more fillers incorporated therein by adding the fillers to monomers (before polymerizing the monomers) under controlled conditions (e.g., low humidity, vacuum pressure, etc.). At least one or more fillers may then be added in these embodiments in accordance with the example methods of the present disclosure.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method of forming a resin and filler composite system, the method comprising:
softening a polymer formed by a moisture sensitive chemical reaction of one or more monomers; and
adding at least one or more fillers to the softened polymer to form a resin and filler composite system;
wherein formation of foam is substantially inhibited when adding at least one or more fillers to the softened polymer.

2. The method of claim 1, wherein softening the polymer includes heating the polymer to above its softening temperature.

3. The method of claim 2, wherein heating the polymer to above its softening temperature includes generally liquefying the polymer.

4. The method of claim 2, wherein heating the polymer to above its softening temperature includes heating the polymer to at least about 95 degrees Celsius.

5. The method of claim 1, wherein the polymer includes a polyurethane.

6. The method of claim 1, wherein the polymer includes a thermoplastic.

7. The method of claim 1, wherein the at least one or more fillers includes a thermally conductive filler material.

8. The method of claim 7, wherein the at least one or more fillers includes boron nitride.

9. The method of claim 1, wherein the resin and filler composite system includes a greater thermal conductivity than the polymer.

10. The method of claim 1, further comprising forming the resin and filler composite system into at least one of a thermal pad and an electromagnetic interference pad.

11. The method of claim 1, wherein the resin and filler composite system is substantially free of silicone.

12. The method of claim 11, wherein the resin and filler composite system includes a thermal conductivity of at least about 3.5 Watts per meter-Kelvin.

13. The method of claim 1, wherein softening the polymer includes heating the polymer.

14. The method of claim 13, wherein softening the polymer includes actively heating the polymer.

15. The method of claim 14, wherein actively heating the polymer includes heating the polymer in an industrial oven.

16. The method of claim 1, further comprising processing the resin and filler composite system into at least one or more gap fillers.

17. A method of forming a resin and filler composite system, the method comprising:
softening a thermoplastic; and
adding at least one or more fillers to the softened thermoplastic to achieve a thermal conductivity of at least about 0.5 Watts per meter-Kelvin.

18. The method of claim 17, further comprising adding at least one or more fillers to the softened thermoplastic to achieve a thermal conductivity of at least about 3.0 Watts per meter-Kelvin.

19. The method of claim 17, further comprising adding at least one or more fillers to the softened thermoplastic to achieve a thermal conductivity of at least about 3.5 Watts per meter-Kelvin.

20. The method of claim 17, wherein softening a thermoplastic includes heating a thermoplastic to about a softening temperature of the thermoplastic.

21. The method of claim 17, wherein the thermoplastic is substantially free of silicone.

22. The method of claim 21, wherein the thermoplastic is entirely free of silicone.

23. A method of forming a thermoplastic and boron nitride composite system that is substantially free of silicone, the method comprising:
heating a thermoplastic to at least about 95 degrees Celsius to generally liquefy the thermoplastic; and
adding boron nitride to the liquefied thermoplastic to achieve a thermal conductivity of at least about 3.5 Watts per meter-Kelvin.

24. The method of claim 23, further comprising processing the thermoplastic and boron nitride composite system into a pad that, at an initial thickness of about 1.0 millimeters, exhibits a thermal resistance of at least about 0.177 degrees Celsius-square inch per Watt at a pressure of about 10 pounds per square inch and at an average temperature of about 50 degrees Celsius.

25. The method of claim 23, wherein the thermoplastic is entirely free of silicone.
